(19) United States
(12) Patent Application Publication
(10) Pub. No.: US 2006/0187143 A1
(43) Pub. Date: Aug. 24, 2006

(54) Dual type LCD module for mobile phone

(75) Inventors: Jin-woo Cho, Seongnam-si (KR); Dong-ok Kwak, Suwon-si (KR); Ki-taek Kim, Yongin-si (KR); Young-ki Kim, Yongin-si (KR); Seong-woon Booh, Yongin-si (KR); Dong-woo Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/324,301

(22) Filed: Jan. 4, 2006

(30) Foreign Application Priority Data
Feb. 18, 2005 (KR) 10-2005-0013580

(51) Int. Cl. G09G 5/00

(52) U.S. Cl. 345/1.1; 361/681

(57) ABSTRACT

A dual type LCD module for a mobile phone includes: a main LCD; a sub LCD; and a bracket interposed between the main LCD and the sub LCD. The main LCD and sub LCD are separated by a first distance by the brackets, which covers a periphery of the main LCD and includes an opening in which the sub LCD is arranged. In accordance with the invention, the weight of the sub LCD is not applied to the main LCD when the phone is shocked, so that the main LCD is prevented from being deformed by the sub LCD.

### CROSS-REFERENCE TO RELATED APPLICATIONS.

This application is based upon and claims the benefit of priority under 35 U.S.C. § 119 from Korean Patent Application No. 10-2005-0013580, filed on Feb. 18, 2005 in the Korean Patent Office, the entire content of which is incorporated herein by reference.

### BACKGROUND OF THE INVENTION

1. Field of the Invention

Devices, systems, and methods consistent with the invention relate to a liquid crystal display (LCD) module, and more particularly, to a dual type LCD module for a mobile phone.

2. Description of the Related Art:

In the related art, foldable mobile phones include a dual type LCD module. Such a dual type LCD module generally includes a main LCD on an inner side of a cover and a sub LCD on an outer side of the cover. This arrangement overcomes drawbacks of a foldable mobile phone with a single LCD on the inside of the cover, which include a user's inconvenience when the user has to unfold the cover of the mobile phone to check various information displayed on the single LCD (e.g., time, message reception status, etc.).

FIG. 1 is a perspective view of a typical foldable mobile phone with a dual type LCD. With reference to FIG. 1, the mobile phone includes a main body 10, a cover 20 coupled to the main body by a hinge, a dual type LCD module 30 combined with the cover 20, and a key pad 40 provided on the front surface of the main body 10. Here, dual type LCD module 30 includes a sub LCD mounted on the outer surface of the cover 20 and a main LCD provided on the inner surface of the cover 20 (the surface facing the keypad in FIG. 1).

FIG. 2 is a cross-sectional view of the cover 20 with the dual type LCD module 30 assembled therein. With reference to FIG. 2, the dual type LCD module 30 is installed between a front cover 21 and the rear cover 23 of the cover 20, and includes a main LCD 31, a sub LCD 33 and a bracket 35.

The sub LCD 33 is stacked on the main LCD 31, and the bracket 35 covers the main LCD 31 to protect it. The bracket 35 has an opening 35a in which the sub LCD is arranged. The front cover 21 and the rear cover 23 are provided with windows 21a and 23a, respectively, and the LCDs 31 and 33 are exposed through the windows 21a and 23a.

Here, the bracket 35 protects the main LCD 31 to avoid breakage when an external impact is applied to the mobile phone (e.g., when a user drops the mobile phone during use or steps on the mobile phone by accident).

However, the arrangement of the dual type LCD module 30 shown in FIG. 2 allows the main LCD 31 to be deformed due to the weight of the sub LCD 33 when the mobile phone is dropped, even though the bracket 35 is provided to protect the main LCD 31. This deformation of the main LCD 31 is undesirable.

### SUMMARY OF THE INVENTION

An aspect of the invention is to provide a dual type LCD module for a mobile phone, wherein a main LCD is not deformed by the weight of a sub LCD when an external impact is applied to the LCD module.

In another aspect of the invention, there is provided a dual type LCD module for a mobile phone, including: a main LCD, a sub LCD; and a bracket interposed between the main LCD and the sub LCD.

In another aspect of the invention, there is provided a dual type LCD module for a mobile phone, including: a main LCD; and a sub LCD, wherein adjacent opposing faces of the main LCD and the sub LCD are separated by a distance.

In another aspect of the invention, there is provided a dual type LCD module for a mobile phone, including: a main LCD; a sub LCD; and support means for supporting the weight of the sub LCD so that the weight of the sub LCD does not deform the main LCD.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a perspective view of a related art mobile phone having an LCD module;

FIG. 2 is a cross-sectional view of the LCD module shown in FIG. 1;

FIG. 3 is a cross-section view of a dual-type LCD module in accordance with an exemplary embodiment of the invention; and

FIG. 4 is an exploded perspective view of the dual type LCD module shown in FIG. 3.

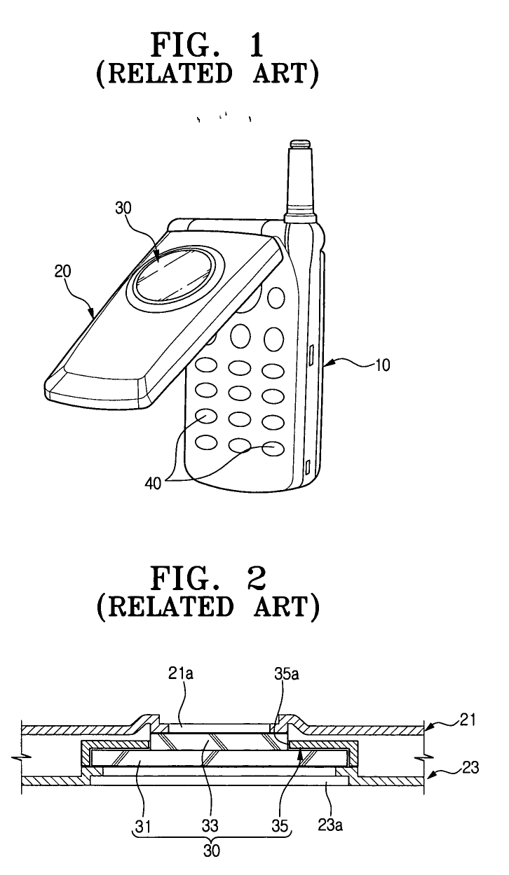

### DETAILED DESCRIPTION OF THE EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way.

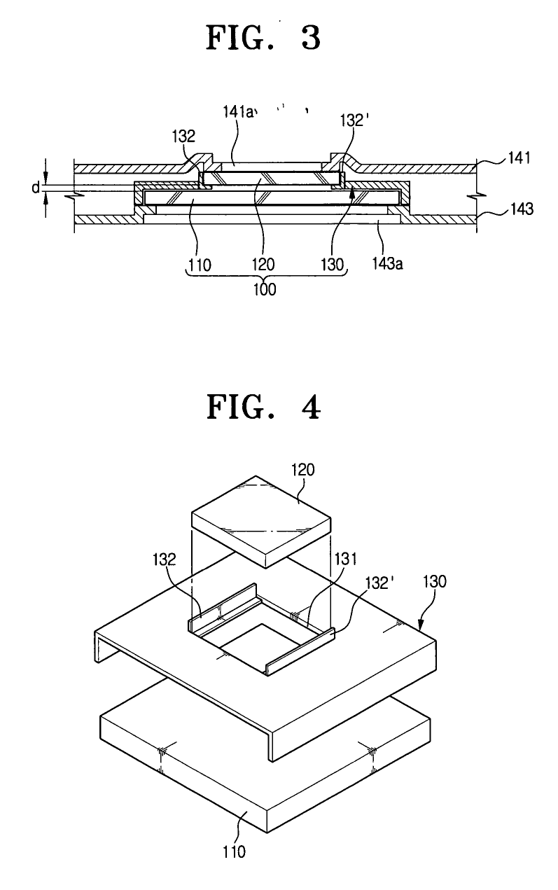

In the exemplary embodiment shown in FIG. 3 and FIG. 4, a dual type LCD module 100 for a mobile phone includes a main LCD 110, a sub LCD 120 and a bracket 130 for supporting the sub LCD 120 and covering the main LCD 110 to protect it.

In accordance with this exemplary embodiment, the main LCD 110 and the sub LCD 120 are arranged in a stacked configuration like other dual type LCD modules. However, the exemplary embodiment differs from other dual type LCD modules because the main LCD 110 and the sub LCD 120 are separated from each other by a distance “d.” In this exemplary embodiment, the bracket 130 is interposed between the main LCD 110 and the sub LCD 120 to support the sub LCD 120, and separate the main LCD 110 and the sub LCD 120 by the distance “d”.

The LCD module 100 described above is provided between a front cover 141 and a rear cover 143 of the cover of a foldable mobile phone. The front cover 141 and the rear cover 143 have windows 141a and 143a, respectively.

The bracket 130 has an opening 131 in which the sub LCD 120 is exposedly arranged. Support ribs 132 and 132′ are provided along the side edges of the opening 131 to receive and support the sub LCD 120.

In FIG. 4, the opening 131 is rectangular because the LCDs 110 and 120 are rectangular, but the shape of the opening 131 can be freely determined depending on the shape of the main and/or sub LCDs.

If the opening 131 is rectangular, the support ribs 132 and 132′ can be provided along the opening 131 on opposite sides, or on all of the sides.

The support ribs 132 and 132′ can be provided as separate members from the bracket 130, or can be integrated as one united body with the bracket 130.

In accordance with the invention, during assembly of the mobile phone, the bracket 130 is arranged on the main LCD 110, and the sub LCD 120 is mounted on and supported by the support ribs 132 and 132′.

Then, the front cover 141 is assembled to the front part of the LCD module 100 and the rear cover 143 is assembled to the rear part of the LCD module 100, so that the cover for the mobile phone is assembled.

That is, in accordance with the invention, the sub LCD is assembled so as to be supported by the bracket 130, unlike the related art dual type LCD module shown in FIG. 2. Accordingly, the invention solves the problem encountered in the related art dual type LCD module, where the main LCD is deformed because the weight of the sub LCD is applied to the main LCD when an external impact is applied to the LCD module.

As described above, in the dual type LCD module of the invention, the weight of the sub LCD is distributed all over the cover via the bracket 130 when an external impact is applied to the cover. Thus, the weight of the sub LCD does not cause deformation of the main LCD when the mobile phone is shocked. Accordingly, it is possible to better protect the main LCD.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A dual type Liquid Crystal Display (LCD) module for a mobile phone, the dual type LCD module comprising:
a main LCD;
a sub LCD; and
a bracket interposed between the main LCD and the sub LCD.

2. The dual type LCD module according to claim 1, wherein the bracket separates adjacent opposing faces of the main LCD and sub LCD by a first distance.

3. The dual type LCD module according to claim 1, wherein the bracket covers a periphery of the main LCD.

4. The dual type LCD module according to claim 1, wherein the bracket comprises an opening in which the sub LCD is exposably arranged.

5. The dual type LCD module according to claim 4, wherein the opening is formed in a shape similar to at least one of the sub LCD and the main LCD.

6. The dual type LCD module according to claim 1, wherein the bracket comprises
support ribs along edges of the opening to support the sub LCD.

7. The dual type LCD module according to claim 6, wherein the opening is rectangular and the support ribs are on two opposite edges of the opening.

8. The dual type LCD module according to claim 6, wherein the opening is rectangular and the support ribs are on all of the edges of the opening.

9. The dual type LCD module according to claim 6, wherein the opening is formed in a shape similar to at least one of the sub LCD and the main LCD.

10. The dual type LCD module according to claim 6, wherein the support ribs are integrated in one united body with the bracket.

11. The dual type LCD module according to claim 6, wherein the support ribs are separately formed from the bracket, and fixed thereto.

12. A dual type Liquid Crystal Display (LCD) module for a mobile phone, the dual type LCD module comprising:
a main LCD; and
a sub LCD,
wherein adjacent opposing faces of the main LCD and the sub LCD are separated by a distance.

13. A dual type Liquid Crystal Display (LCD) module for a mobile phone, the dual type LCD module comprising:
a main LCD;
a sub LCD; and
support means for supporting a weight of the sub LCD so that the weight of the sub LCD does not deform the main LCD.

14. The dual type LCD module according to claim 13, wherein the support means protects the main LCD from damage.

15. The dual type LCD module according to claim 13, wherein the support means comprises a bracket interposed between the main LCD and the sub LCD.

16. The dual type LCD module according to claim 15, wherein the bracket separates adjacent opposing faces of the main LCD and sub LCD by a distance.

17. The dual type LCD module according to claim 15, wherein the bracket covers a periphery of the main LCD.

18. The dual type LCD module according to claim 15, wherein the bracket comprises an opening in which the sub LCD is exposably arranged.

19. The dual type LCD module according to claim 15, wherein the opening is formed in a shape similar to a shape of at least one of the sub LCD and the main LCD.
